(19) United States
(12) Patent Application Publication
(10) Pub. No.: US 2026/0348280 A1
(43) Pub. Date: Nov. 5, 2026

(54) MODULARITY OF AN AIRCRAFT TURBINE ENGINE BY WAY OF AN AXIAL AND ROTATIONAL LOCKING DEVICE, AND CORRESPONDING MOUNTING METHOD

(71) Applicant: SAFRAN AIRCRAFT ENGINES, Paris (FR)

(72) Inventors: Vincent Francois Georges MILLIER, Moissy-Cramayel (FR); Alessandro ALLORA, Moissy-Cramayel (FR); Julien Fabien Patrick BECOULET, Moissy-Cramayel (FR); Olivier BELMONTE, Moissy-Cramayel (FR)

(21) Appl. No.: 19/113,208

(22) PCT Filed: Sep. 25, 2023
(86) PCT No.: PCT/FR2023/051469

§ 371 Date: Mar. 19, 2025

(30) Foreign Application Priority Data
Sep. 26, 2022 (FR) FR2209707

(51) Int. Cl. F01D 5/02

(52) U.S. Cl. CPC F01D 5/026; F05D 2220/323; F05D 2230/51; F05D 2260/31

(57) ABSTRACT

A turbine engine including a first module including a speed reducer having an input shaft, a second module including a low-pressure compressor which is connected to the first module, a third module including a low-pressure shaft which is centered on a longitudinal axis X and which includes an upstream end connected to the input shaft, and a locking device configured to axially immobilise the second module with respect to the first module and to the second module, the locking device including a first nut screwed onto a thread of the low-pressure shaft and in contact with an annular projection of the second module, an anti-displacement member configured to axially lock the first nut, a second nut screwed onto a thread of the second module and configured to axially immobilise the anti-displacement member, and a third nut screwed onto the anti-displacement member.

### FIELD OF THE INVENTION

The present invention relates to solutions for facilitating the modularity of an aircraft turbine engine.

### TECHNICAL BACKGROUND

The prior art comprises the documents FR-A1-3115822, FR-A1-2896827, and FR-A1-3013388.

An aircraft turbine engine is often constructed as an assembly of modules, each of which may comprise stationary portions and movable portions. A module is defined as a sub-assembly of an engine which has geometrical characteristics at the level of its interfaces with the adjacent modules which are sufficiently precise for it to be delivered individually, and which has undergone a separate balancing when it comprises rotating portions. The assembly of the modules allows to build a complete engine, reducing to a minimum the balancing and matching operations of the interfacing parts.

The modularity of a turbine engine is a key element for its maintenance. Indeed, during an intervention, the parts must be easily accessible without having to dismantle a large number of portions of the engine. In practice, the turbine engine is configured so that it may be divided into major and minor modules. For example, for a turbine engine with an upstream fan (the terms “upstream” and “downstream” are used in relation to the flow of gases in the turbine engine), it is configured with three major modules: a major upstream module for the front portion comprising the fan, a major intermediate module for the intermediate portion comprising the low-pressure compressor and the high-pressure body, and a major downstream module for the rear portion comprising the low-pressure turbine and the low-pressure shaft. In this particular example, the low-pressure body is divided into two modules.

The low-pressure body may also be divided into three modules with the low-pressure compressor arranged independently of the rest of the intermediate major module.

The maintenance is particularly difficult on a turbine engine comprising a reducer and possibly a system for changing the pitch of the vanes upstream. The speed reducer is attached either to the upstream module or to the intermediate major module. The speed reducer comprises an input shaft connected to a rotor of the low-pressure compressor and to a rotor of the low-pressure turbine. In particular, the intermediate major module and the downstream major module, which comprise members of the low-pressure body, and the upstream module, are attached to each other by means of a nut that is centered on the axis of the turbine engine and serves to axially tighten the input shaft of the speed reducer and the low-pressure shaft.

During a maintenance operation on the speed reducer or other members of the turbine engine of one of the modules described above, this nut must be unscrewed from upstream using a tool that is inserted into the turbine engine along its longitudinal axis. This allows the downstream major module to be unsecured. However, this is not enough to completely free the input shaft, as the latter is also connected to the rotor of the low-pressure compressor by means of a journal that is attached to the input shaft and must also be dismantled. The rotor of the low-pressure compressor of the intermediate major module also comprises bearings, the internal rings of which are attached to the input shaft.

The problem in this case is therefore the number of parts that need to be dismantled to disassemble a member from one of the modules, and specifically the input shaft. It is generally not possible to dismantle the speed reducer without disassembling a large portion of the turbine engine, including the upstream module, the intermediate major module and the downstream major module.

The present invention offers a solution to at least some of the above problems which simplifies the modularity of an aircraft turbine engine and does not penalize the performance of the turbine engine.

### SUMMARY OF THE INVENTION

This is achieved in accordance with the invention by means of a turbine engine, in particular for an aircraft, the turbine engine having a longitudinal axis and comprising:
a first module comprising a speed reducer which comprises an input shaft centered on the longitudinal axis,
a second module comprising a low-pressure compressor, the second module being connected to the first module,
a third module comprising a low-pressure shaft which is centered on the longitudinal axis, the low-pressure shaft comprising an upstream end connected to the input shaft, and
a locking device configured so as to axially immobilize the third module with respect to the first module,
the locking device is configured so as to axially immobilize the second module with respect to the first module and the third module and comprises:
a first nut which is screwed onto a thread of the upstream end of the low-pressure shaft and in contact with an annular projection on the second module, an anti-displacement member configured to axially limit the displacement of the first nut,
a second nut which is screwed onto a thread of the second module and which is configured so as to axially immobilize the anti-displacement member, and
a third nut which is screwed onto the anti-displacement member.

Thus, this solution allows to achieve the above-mentioned objective. The module of the low-pressure turbine and of the low-pressure compressor may thus be dismantled in a reduced number of operations compared with the other modules and without dismantling the other adjacent modules. This applies in particular to the input shaft, which is subject to a great deal of stress and may now be checked and replaced quickly and easily. The input shaft may be dismantled independently of the other shafts using the locking device, which comprises a number of nuts and members tightened/engaged on each other to perform anti-rotation and anti-displacement functions or axial locking. In addition, this configuration provides a greater modularity and saves time when it comes to inspecting parts and dismantling some of them independently. This modularity is part of a drive to reduce environmental impact, since it means that only the necessary members may be repaired and checked, reducing the downtime of the turbine engine.

The turbine engine according to the invention may comprise one or more of the following characteristics, taken in isolation from each other, or in combination with each other:
the locking device comprises a locking element cooperating with the first nut and the third nut.
the first nut is mounted so as to rotate freely about the longitudinal axis.
the second module comprises a low-pressure compressor shaft which is connected to the low-pressure compressor and which is centered on the longitudinal axis, the low-pressure compressor shaft being connected to the input shaft and to the low-pressure shaft.
the low-pressure compressor shaft comprises the annular projection and the first nut comprises a downstream face in contact with an upstream face of the annular projection.
the anti-displacement member comprises a plurality of teeth each configured to engage in a notch in the low-pressure compressor shaft. the plurality of teeth has an external diameter greater than an external diameter of a collar of the first nut. the second nut is configured to be locked against rotation by a first locking system.
the first locking system comprises:
   a first ring element, centered on the longitudinal axis and configured to come in contact with a radial annular face of the second nut, the first ring element comprising a plurality of radial teeth each configured to engage in a radial notch of the low-pressure compressor shaft, and
   a second ring element, centered on the longitudinal axis and received in an annular groove of the second nut, the annular groove being arranged upstream of the radial annular face.
the turbine engine comprises a second locking system configured so as to enclose the third nut in an annular cavity of the input shaft.
the third nut is configured to be locked in translation upstream by at least a second locking system.
the second locking system comprises:
   a third ring element, centered on the longitudinal axis, and comprising a plurality of radial teeth which have downstream faces configured to be in contact with an annular face of the input shaft, the third ring element comprising an upstream face with which a downstream face of the third nut abuts against, and
a fourth ring element, centered on the longitudinal axis, received in an annular groove of the input shaft, the fourth ring element facing the downstream faces of the radial teeth.
the first module comprises a fan which is connected to a fan shaft and which is arranged upstream of the second module, the low-pressure shaft driving the fan shaft in rotation by means of the speed reducer.
the fan is ducted.
the reducer is located in a lubrication enclosure.
the low-pressure compressor shaft is independent of the input shaft and of the low-pressure shaft.
the low-pressure shaft comprises an upstream end which extends within the low-pressure compressor shaft, the first nut, the second nut and the third nut being mounted within the low-pressure compressor shaft.
the low-pressure compressor shaft is connected to an upstream end of the low-pressure shaft and to a downstream end of the input shaft.
the low-pressure compressor shaft is connected to a rotor of the low-pressure compressor.
the low-pressure compressor shaft is connected to the rotor of the low-pressure compressor by means of a journal, the journal being secured to the rotor of the low-pressure compressor and of the low-pressure compressor shaft.
the journal is formed in one-part with the low-pressure compressor shaft.
the third module comprises a low-pressure turbine connected to the low-pressure shaft, the low-pressure shaft comprises a downstream end connected to a low-pressure turbine rotor.
the input shaft of the speed reducer has an internal diameter which is smaller than the internal diameter of the low-pressure compressor shaft.
the input shaft of the speed reducer has an internal diameter which is greater than the internal diameter of a downstream end of the low-pressure compressor shaft.
the first nut comprises a thread which is screwed onto the third module.
the radial notches of the low-pressure compressor shaft extend radially outwards from the second nut.
the locking device is configured so as to immobilize the low-pressure shaft relative to the low-pressure compressor shaft, the input shaft relative to the low-pressure compressor shaft and the input shaft relative to the low-pressure shaft.

The invention further relates to an aircraft comprising at least one turbine engine as above-mentioned.

The invention also relates to a method for mounting a turbine engine as aforesaid, the method comprising the steps of:
screwing the first nut onto the low-pressure shaft,
limiting in translation the first nut on the low-pressure compressor shaft along the longitudinal axis by means of the anti-displacement member,
immobilizing axially the anti-displacement member by means of the second nut, and
screwing the third nut onto the anti-displacement member.

In accordance with a characteristic of the method, it comprises a step of engaging a locking element on the third nut and on the first nut.

### BRIEF DESCRIPTION OF THE FIGURES

Further characteristics and advantages of the invention will become apparent from the following detailed description, for the understanding of which reference is made to the attached drawings wherein:

FIG. 1 is a schematic half-view of an aircraft turbine engine in axial cross-section;

FIG. 2 is a detail view of FIG. 1 according to the invention;

FIG. 3 is a perspective view showing a shaft of one of the modules of a turbine engine according to the invention;

FIG. 4 is a perspective view of a shaft wherein a first nut is mounted following a step in a mounting method according to the invention;

FIG. 5 is a perspective view of a shaft wherein an anti-displacement member for a first nut is mounted following a step in a mounting method according to the invention;

FIG. 6 is a detail view of FIG. 5 according to the invention;

FIG. 7 is a perspective view, substantially in a longitudinal sectional plane, of a shaft wherein a second nut and a locking system for this nut are mounted in accordance with a step in a mounting method according to the invention;

FIG. 8 illustrates in greater detail a first system for locking a second nut in rotation according to the invention;

FIG. 9 is a detail view of FIG. 7, substantially following a radial sectional plane of the shaft wherein the second nut according to the invention is mounted;

FIG. 10 is a perspective view of a shaft wherein a third nut is mounted following a step in a mounting method according to the invention;

FIG. 11 is a perspective view of a shaft wherein a locking system is mounted following a step in a mounting method according to the invention;

FIG. 12 illustrates in more detail a third nut according to the invention;

FIG. 13 is a perspective view of a step in the mounting method described in FIG. 11;

FIG. 14 is a perspective view of a shaft wherein a locking system is mounted following a step in a mounting method according to the invention;

FIG. 15 is a perspective view wherein two shafts are assembled together following a step in a mounting method according to the invention; and

FIG. 16 is a perspective view wherein a locking device is used to lock shafts in translation and in rotation following a step in a mounting method according to the invention.

### DETAILED DESCRIPTION OF THE INVENTION

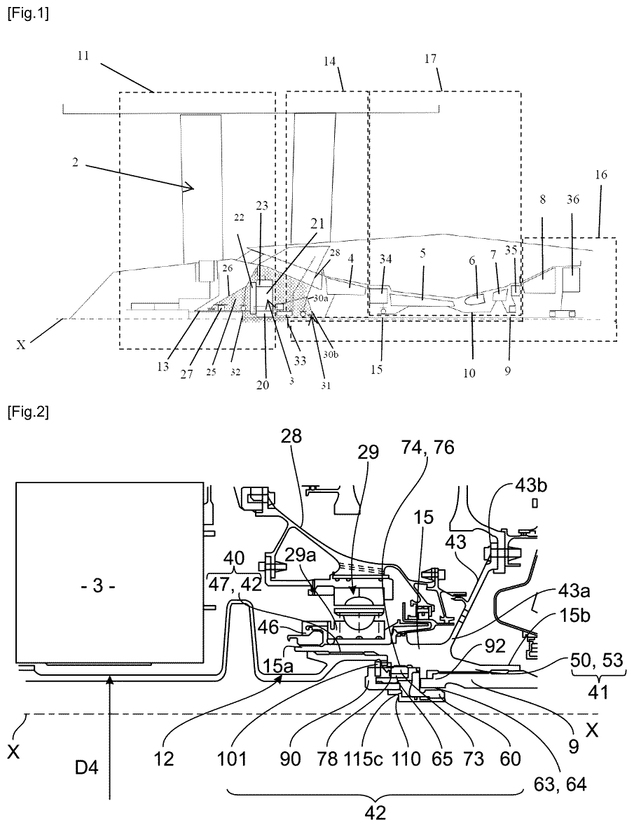

The invention applies to an aircraft turbine engine 1 such as that shown in FIG. 1, which is a turbojet engine equipped with a ducted fan 2 and a speed reducer 3. Of course, the invention is not limited to a turbojet engine and may be applied to any type of turbine engine equipped in particular with a speed reducer.

The turbine engine 1 extends along a longitudinal axis X, which is generally the axis of rotation of its rotors. The turbine engine 1 comprises, from upstream to downstream along the longitudinal axis X and the gas flow, a fan 2, a low-pressure compressor 4, a high-pressure compressor 5, an annular combustion chamber 6, a high-pressure turbine 7 and a low-pressure turbine 8.

The low-pressure compressor 4 and the low-pressure turbine 7 are mechanically connected by a low-pressure shaft 9 so as to form a low-pressure body. The high-pressure compressor 5 and the high-pressure turbine 8 are mechanically connected by a high-pressure shaft 10 so as to form a high-pressure body. The low-pressure shaft 9 extends at least partly inside the high-pressure shaft 10 and are coaxial.

The turbine engine 1 is configured with several modules that are assembled/related to each other, making it easier to maintain. Shafts and/or interfaces are used to make these connections.

A first module 11 comprises the fan 2 and the speed reducer 3. Advantageously, the latter comprises an input shaft 12 which is centered on the longitudinal axis X. Advantageously, the input shaft 12 forms part of the first module 11.

The fan 2 comprises a fan shaft 13 which is advantageously driven in rotation by the low-pressure shaft 9 via the speed reducer 3.

A second module 14 comprises the low-pressure compressor 4. The second module 14 also comprises a low-pressure compressor shaft 15 to which the low-pressure compressor 4 is connected. The low-pressure compressor shaft 15 is centered on the longitudinal axis X.

A third module 16 comprises the low-pressure turbine 7 and the low-pressure shaft 9 which is centered on the longitudinal axis X. Advantageously, the low-pressure shaft 9 comprises an upstream end 9a connected to a rotor of the low-pressure compressor and a downstream end 9b connected to a low-pressure turbine rotor. The upstream end 9a is connected to the input shaft 12 of the speed reducer 3.

A fourth module 17 comprises the high-pressure compressor 5.

Advantageously, the fourth module 17 comprises the high-pressure turbine 7. The fourth module 17 also comprises the annular combustion chamber 6, which is interposed axially between the high-pressure compressor 5 and the high-pressure turbine 7.

In this configuration, the low-pressure body of turbine engine 1 is divided into three modules. Alternatively, the low-pressure body is divided into two modules with the low-pressure compressor forming part of the second module.

The speed reducer 3 (referred by its acronym “RGB”) comprises an epicyclic gear train. Of course, the speed reducer may comprise a planetary gear.

The speed reducer 3 typically comprises a sun gear 20 (or internal planetary gear), a plurality of planet gears 21 (which are pinions), a planet carrier 22 and an external ring gear 23 (or external planetary gear). The sun gear 20 is centered on the longitudinal axis X. The external ring gear 23 is centered on the longitudinal axis X and extends around the sun gear 20. The planet gears 21 are positioned between the sun gear 20 and the external ring gear 23 and are carried by the planet carrier 22. The planet gears 21 are each mounted so that they may rotate freely about a planet gear axis by means of a bearing and mesh with external toothing on the sun gear 20 and internal toothing on the external ring gear 23.

In this case, the external ring gear 23 is immobile and attached to a stator of the turbine engine, which in this case is an inlet casing 24. The sun gear 20 is mobile in rotation and is coupled to the input shaft 12, which in turn is connected to the low-pressure shaft 9. The planet carrier 22 is also mobile in rotation and coupled to the fan shaft 13. The fan 2 is therefore driven in rotation by the low-pressure shaft 9 by means of the reducer 3.

In the case of a planetary gear reducer, the external ring gear is secured in rotation to the fan shaft, and the planet carrier is secured to a stationary structure such as the inlet casing 24.

The reducer 3 in FIG. 1 is advantageously arranged in a lubrication enclosure 25 which extends around the longitudinal axis X. The enclosure 25 is therefore generally annular in shape. The enclosure 25 is delimited by the fan shaft 13 and the input shaft 12 at the level of its internal periphery. At its external periphery, the lubrication enclosure 25 is advantageously, but not exclusively, delimited by the inlet casing 24 which extends around the reducer 3. The enclosure 25 is delimited upstream by a first annular bearing support 26. The first bearing support 26, for example, comprises an external end which is attached to the inlet casing 24 and an internal end which holds the external race ring of two rolling bearings 27.

Advantageously, the rolling bearings 27 comprise internal rings which are attached to the fan shaft 13. These bearings allows the guiding in rotation of at least the fan shaft 13. One of the upstream bearings closest to the speed reducer 3 also helps to guide the planet carrier in rotation in a more stable manner. This bearing closest to the reducer is optional. Finally, the enclosure 25 is delimited downstream by a second annular bearing support 28, for example. The second bearing support 28 comprises an external end 28a which is attached to the inlet casing 24 and an internal end 28b which holds the external rings of two rolling bearings 29.

Advantageously, the two downstream rolling bearings 29 allow the guiding of the input shaft of the speed reducer and of the low-pressure compressor shaft (which is secured to the input shaft).

In this example, the rolling bearings 29 comprise internal rings which are attached to the low-pressure compressor shaft 15. The second bearing support 28 comprises an annular shell 30, the first end 30a of which is attached to the second bearing support 28 and the second end 30b of which cooperates with sealing elements 31 installed around the low-pressure compressor shaft 15.

With reference to FIG. 1, the enclosure 25 also comprises sealing means for sealing the enclosure 25. These sealing means comprise a first removable cover 32 configured to seal the enclosure 25 upstream and a second removable cover 33 configured to seal the enclosure downstream. The first cover 32 is mounted inside the fan shaft 13 and is close to the speed reducer 3 along the longitudinal axis. The second cover 33 is mounted inside the input shaft 12 and at its downstream end 12b. This second cover 33 is mounted downstream of the speed reducer 3 (and more precisely downstream of the flexibility means).

Advantageously, both the low-pressure compressor shaft 15 and the input shaft 12 are hollow. The low-pressure shaft 9 is also hollow.

The turbine engine 1 also comprises an intermediate casing 34 which is interposed between the low-pressure compressor 4 and the high-pressure compressor 5, an inter-turbine casing 35 which is interposed between the high-pressure turbine 7 and the low-pressure turbine 8 and an exhaust casing 36 which is located downstream of the low-pressure turbine 8.

In FIG. 2, an assembly of shafts of the turbine engine are interconnected and locked in position relative to each other. The assembly comprises a first shaft and a second shaft. In this example, the first shaft is the input shaft 12. The second shaft is the low-pressure compressor shaft 15. The shaft assembly also comprises a third shaft which is the low-pressure shaft 9.

First coupling means 40 are configured so as to (removably) connect the first module 11 and the second module 14. Second coupling means 41 are configured so as to (removably) connect the second module 11 and the third module 15.

The turbine engine comprises a locking device 42 configured so as to connect the modules together and to axially immobilize the modules together. More specifically, the locking device is configured so as to immobilize the second module axially with respect to the first module and to the third module.

The low-pressure compressor shaft 15 is connected to the low-pressure compressor rotor by means of a journal 43. In particular, the second module 14 comprises (in addition to the low-pressure compressor) the journal 43 which is rotationally secured to the rotor of the low-pressure compressor and the low-pressure compressor shaft 15. The low-pressure compressor shaft 15 is connected to the input shaft 12.

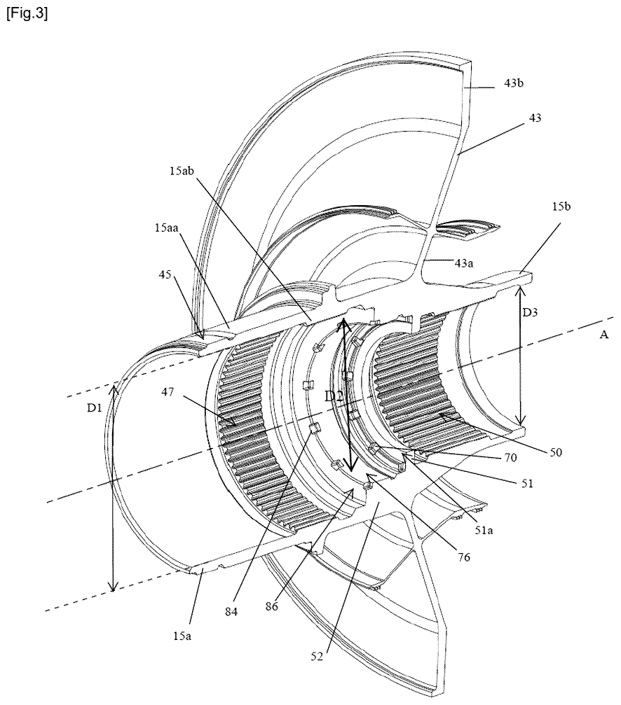

As shown in FIG. 3, the low-pressure compressor shaft 15 comprises a generally straight cylindrical shape with axis A. Advantageously, the low-pressure compressor shaft extends between an upstream end 15a and a downstream end 15b. The annular journal 43 extends radially from an external surface of the low-pressure compression shaft 15 at a first end 43a. The journal 43 comprises a second end 43b which is secured to the rotor via attachment members such as a threaded rod (screw) and a nut. In the example shown, the journal 43 is formed in one-part with the low-pressure compressor shaft 15. Alternatively, the journal 43 is an insert and its internal end 43a is attached and axially immobilized to the downstream end 15b of the low-pressure compressor shaft 15.

Advantageously, the low-pressure compressor shaft 15 comprises an annular bearing surface 44 which rises radially from its external surface. The internal ring 29a of one of the bearings 29 is in axial contact with this annular bearing surface 44.

The low-pressure compressor shaft 15 comprises an external thread 45 which is configured to engage with an internal thread of a bearing nut 46 which axially locks the internal ring 29a. The external thread 45 is arranged towards the upstream end 15a of the low-pressure compressor shaft 15.

As previously stated, the low-pressure compressor shaft 15 is connected to the input shaft 12. The low-pressure compressor shaft 15 is coupled to the input shaft 12 via splines so as to transmit a rotation torque. To this end and as shown in FIG. 2, the first coupling means 40 comprise first internal splines 47 which are formed on an internal surface 48 of the low-pressure compressor shaft 15. The first internal splines 47 are oriented along the axis A (and along the longitudinal axis) and are regularly arranged around the axis A. The first internal splines 47 are configured to engage with corresponding first external splines 49 of the input shaft 12. The first internal splines 47 are advantageously located close to, but not limited to, the upstream end 15a of the shaft 15.

The low-pressure compressor shaft 15 comprises second internal splines 50 which are formed on the internal surface 48. These second external splines 50 are oriented along the axis A and are evenly distributed around this axis A. Advantageously, they are located at the level of the downstream end 15b of the low-pressure compressor shaft.

In the example shown, the low-pressure compressor shaft 15 comprises a first shaft segment 15aa, a second shaft segment 15ab and a third shaft segment 15ac. The first segment 15aa comprises an internal diameter D1 which is greater than the internal diameter D2 of the second segment 15ab. The internal diameter D2 of the second segment 15ab is greater than the internal diameter D3 of the third segment 15ac.

Advantageously, but without limitation, the low-pressure compressor shaft 15 comprises an annular projection 51 which extends radially inwards therefrom. The annular projection 51 is arranged between the first shaft segment 15aa and the third shaft segment 15ac. More specifically, the annular projection 51 is arranged between the second segment 15ab and the third segment 15ac. In this example, the annular projection 51 is formed upstream of the splines 50.

The low-pressure compressor shaft 15 further comprises an annular shoulder 52 extending radially inwardly therefrom. The shoulder 52 is arranged between the first shaft segment 15aa and the third shaft segment 15ac. More specifically, the annular shoulder 52 is arranged upstream of the annular projection 51 along the longitudinal axis X.

In FIGS. 2 and 3, the downstream end 12b of the input shaft 12 extends inside the low-pressure compressor shaft 15. The corresponding first external splines 49 are formed on an external surface of the input shaft 12. The first external splines 49 are located at the downstream end 12b of the shaft 12. The latter has an external diameter at the level of the downstream end 12b which is advantageously substantially smaller than the internal diameter D1 of the first segment 15aa of the low-pressure compressor shaft 15.

The input shaft 12 also has an external diameter D4 at the level of the speed reducer 3 which is advantageously smaller than the external diameter of its downstream end 12b. The efficiency of the turbine engine also depends on the radial overall dimensions of the speed reducer, the diameter of the input shaft 12 must be small so that the ratio of the diameters of the external ring gear and the sun gear is close to 1.

Advantageously, the diameter D4 of the input shaft 12 is between:
a sufficient radius for the rotation torque to be transmitted,
a sufficient radius to allow an external tooling (described later) to be passed inside the input shaft 12,
as small a radius as possible to save weight, and
a radius as low as possible to allow height for the flexible elements (the height of these elements determines the flexibility of the part).

Advantageously, the reduction ratio of the speed reducer is between 2.5 and 7. The diameter of the input shaft 12 must be small enough to achieve the desired reduction ratio, yet large enough to accommodate the torque and a tool. The ratio between the diameter of the ring gear and the diameter of the input shaft 12 must be the reduction ratio−1 (the Willis formula expressing a reduction ratio between the ring gear and the sun gear, in the reference frame of the planet carrier).

The input shaft 12 is flexible enough so as to avoid hyper-statism in the speed reducer 3. Advantageously, but without limitation, the input shaft 12 comprises bellows which, together with the splines, allow this flexibility to be achieved. In this way, a misalignment may occur between the input shaft 12 and the low-pressure compressor shaft 15, which is particularly advantageous in the case of a relatively long engine.

In FIG. 1, the low-pressure compressor shaft 15 is secured in rotation to the low-pressure shaft 9. The low-pressure compressor shaft 15 is coupled to the low-pressure shaft 9, advantageously by means of splines, so as to transmit a rotation torque. The second coupling means 41 are advantageously formed by the splines. In particular, the upstream end 9a of the low-pressure shaft 9 extends inside the low-pressure compressor shaft 15. The low-pressure shaft 9 comprises second external splines 53 which correspond to and engage with the second internal splines 50 of the low-pressure compressor shaft 15. The second external splines 53 are arranged on an external surface of the bottom shaft 9 and towards its upstream end. The low-pressure shaft 9 has an external diameter (at the level of its upstream end 9a) which is substantially smaller than the diameter of the third segment 15ac of the low-pressure compressor shaft 15.

The locking device 42 is configured so as to immobilize the low-pressure shaft 9 relative to the low-pressure compressor shaft 15, the input shaft 12 relative to the low-pressure compressor shaft 15 and the input shaft 12 relative to the low-pressure shaft 9.

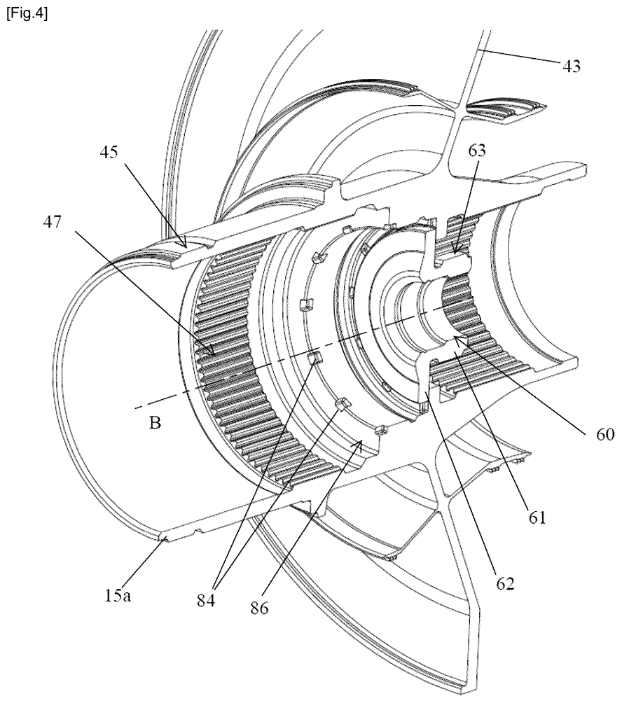

With reference to FIG. 4, the locking device 42 comprises a first nut 60 which is configured so as to at least partially axially lock the low-pressure shaft 9 with respect to the low-pressure compressor shaft 15. Advantageously, the first nut 60 is screwed onto a thread on the upstream end 9a of the low-pressure shaft 9 and comes in contact with an annular projection 51 on the second module 14. The first nut 60 is configured to axially immobilize the low-pressure shaft 9 with respect to the low-pressure compressor shaft 15 and to take up the axial thrust of the low-pressure turbine.

Advantageously, the first nut 60 comprises a cylindrical body 61 with an axis of revolution B. The first nut 60 comprises a collar 62 which extends radially outwards from one end of the cylindrical body 61. In this example, the first nut 60 comprises an L-shaped axial cross-section.

The first nut 60 is screwed onto the low-pressure shaft 9 and is centered on the longitudinal axis. Advantageously, the first nut 60 is arranged radially between the low-pressure compressor shaft 15 and the low-pressure shaft 9. More specifically, the first nut 60 comprises an external thread 63 which engages with an internal thread 64 of the low-pressure shaft 9. The external thread 63 is supported by an external surface of the cylindrical body 61. The internal thread 64 is advantageously located at the upstream end 9a of the low-pressure shaft 9.

In this example, the external diameter of the nut 60, at the level of the cylindrical body 61, is smaller than the internal diameter of the low-pressure shaft 9. We may see that the internal diameter of the nut is smaller than the internal diameter of the input shaft 12 (see FIG. 2).

The collar 62 of the first nut 60 comprises an annular face configured to come in contact with an annular surface complementary to the annular projection 51. In particular and advantageously, the annular face is a downstream annular face 62b and the complementary annular surface is a complementary upstream annular surface 51a.

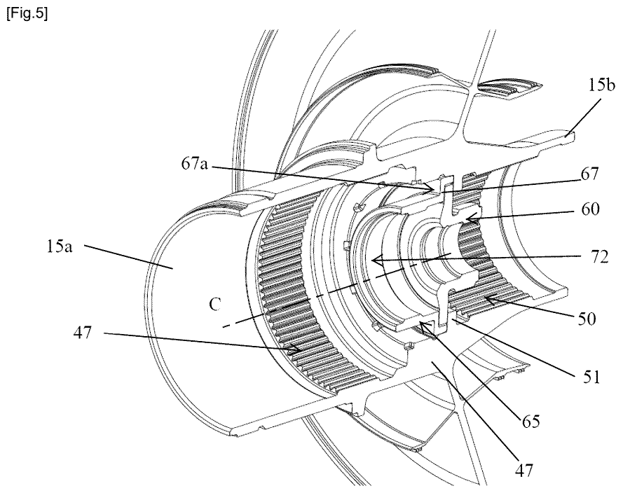

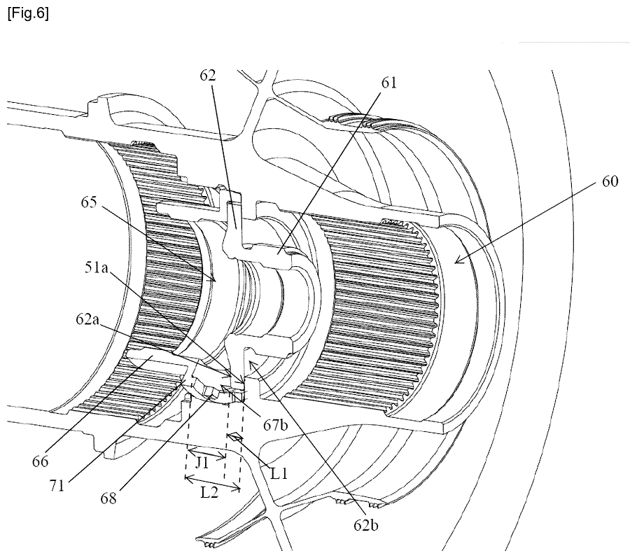

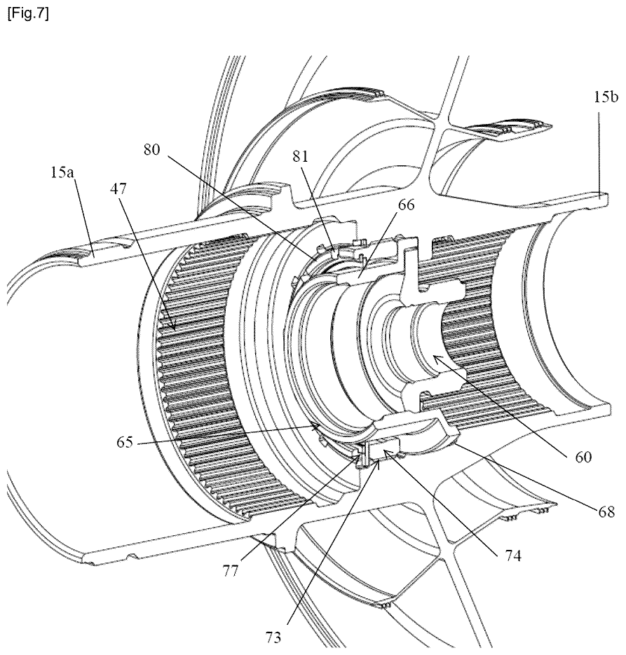

With reference to FIGS. 5 and 6, the locking device 42 comprises an anti-displacement member 65 which is configured so as to “lower” the attachment means (here threading) and allow the assembly between the input shaft 12 and a third nut 90 described later (in particular the engagement of the internal thread 72 of the cylindrical body 66 of the anti-displacement member 65 and the external thread 95 of the cylindrical body 90a of the third nut 90).

Advantageously, the collar 62 is arranged between the anti-displacement member 65 and the annular projection 51.

Advantageously, the first nut 60 is mounted so as to rotate freely in the low-pressure compressor shaft 9, as will be explained later. There is some axial and radial clearance between the other parts. When the various members are loosened, the first nut 60 may move axially and rotate freely within a short space. When the various members are tightened, a first rotation locking system 77 is in abutment with the anti-displacement member 65. The latter allows the first nut to move axially (depending on the amount of clearance provided). The first nut 60 faces and/or is in abutment with the annular projection 51 on the compressor shaft 15.

Advantageously, the anti-displacement member 65 comprises a cylindrical body 66 with an axis of revolution C. When installed, the anti-displacement member 65 is centered on the axis X. Advantageously, the anti-displacement member 65 comprises an annular wing 67 which extends radially outwards from one end of the cylindrical body 66. A plurality of teeth 68 extend from a downstream face 67b of the annular wing 67 and along the axis of revolution C. The teeth 68 are located in particular close to the external peripheral rim 69 of the annular wing 67. The downstream face 67b faces an upstream annular face 62a of the collar 67 of the first nut 60.

Advantageously, at least one axial clearance J1 is provided between the downstream face 67b and the upstream annular face 62a, allowing the rotation of the first nut 60 about the longitudinal axis X.

The anti-displacement member 65 comprises teeth 68 (those described above) which are configured to engage respectively in notches 70 of complementary shape in the second module. In particular, as may be seen in FIG. 3, the low-pressure compressor shaft 15 comprises notches 70 which are oriented along the longitudinal axis. Advantageously, the notches 70 are located upstream of the annular projection 51.

When installed, the teeth 68 extend radially outside the annular edge 71 of the collar 62 of the first nut 60. In other words, the external diameter of the plurality of teeth 68 is greater than the external diameter of the annular edge 71 of the collar 62.

The distance L1 measured between the bottom of the notches 70 and the downstream face 67b (when installed along the longitudinal axis X) is greater than the distance L2 measured between the upstream annular surface 51a complementary to the projection 51 and the downstream face 67b. In this example, the bottom of the notches 70 lies in the same plane as the complementary upstream annular surface 51a. This difference between the distances L1 and L2 creates the axial clearance J1, which is referenced in FIG. 6.

In FIG. 5, the anti-displacement member 65 comprises an internal thread 72 formed on the internal surface of its cylindrical body 66.

Advantageously, the external diameter of the cylindrical body 66 of the anti-displacement member 65 is greater than the external diameter of the cylindrical body 61 of the first nut 60.

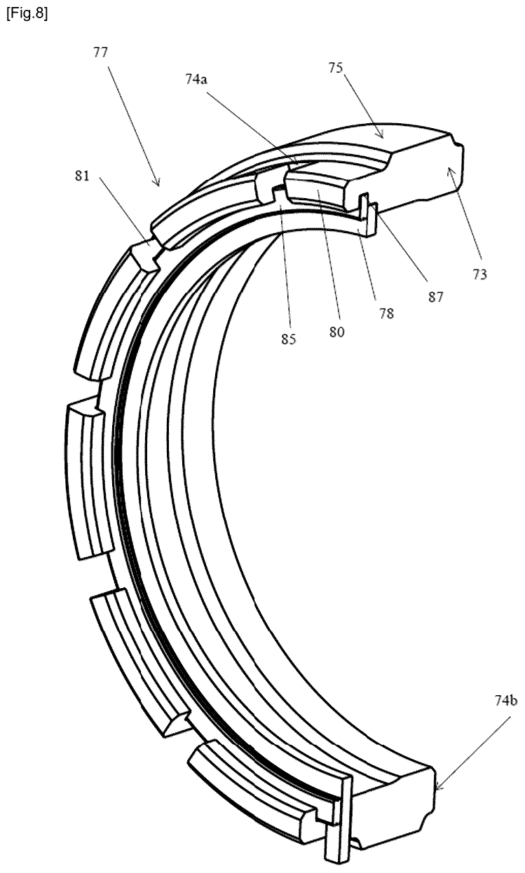

With reference to FIG. 7, the locking device 42 also comprises a second nut 73 which is screwed onto a thread of the second module 14 and which is configured so as to axially immobilize the anti-displacement member 65, i.e. along the longitudinal axis X. The second nut 73 comprises a cylindrical body whose axis is coaxial with the longitudinal axis. Advantageously, the cylindrical body extends between a first annular face 74a and a second annular face 74b. The second nut 73 comprises an external thread 74 formed on its external surface 75 and which is configured to be engaged with an internal thread 76 of the low-pressure compressor shaft 15. The internal thread 76 is provided at the level of the second shaft segment 15ab.

The second nut 73 has an external diameter which is greater than the external diameter of the anti-displacement member 65. The internal diameter of the second nut 73 is also greater than the external diameter of the anti-displacement member 65. A radial space is provided between the second nut 73 and the anti-displacement member 65. This radial space helps to avoid the transitions of parasitic forces and to integrate the locking rings (not shown) of the second nut 73. When installed, the second annular face 74b of the second nut 73 is in contact with an upstream face 67a of the annular wing 67.

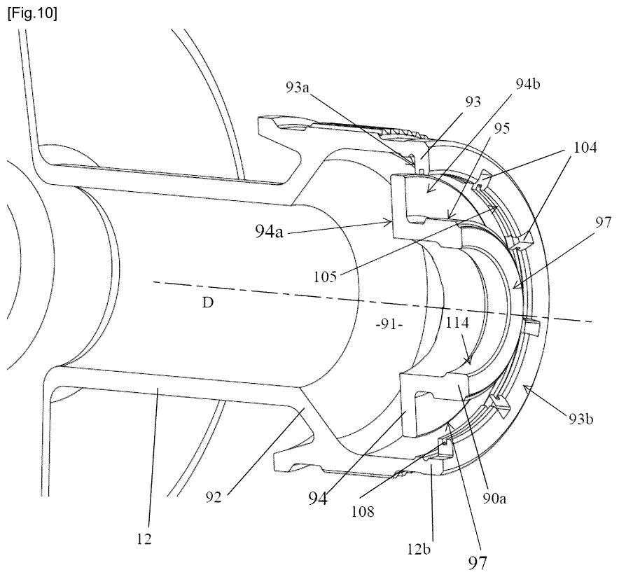

As may also be seen in FIGS. 7, 8 and 9, the second nut 73 is locked against rotation by a first locking system 77. The first rotation locking system 77 advantageously comprises a first ring element 78, centered on the longitudinal axis, configured to come in contact with the first annular face 74a of the second nut 73. Lugs 80 extend from and away from the first annular face 74a of the second nut 73, radially inwards.

Advantageously, each lug 80 extends over an angular sector around the longitudinal axis. The lugs 80 are also spaced apart to form slots 81. In this way, slots 81 and lugs 80 alternate around the longitudinal axis.

The first ring element 78 comprises a plurality of radial teeth 82 extending from an external peripheral edge (not shown) thereof. The radial teeth 82 are evenly distributed around the longitudinal axis X. Each radial tooth 82 is configured to engage in a corresponding radial notch 84 on the low-pressure compressor shaft 15. Advantageously, the radial notches 84 (shown in FIG. 3) are open on the internal surface 48 and face the inside of the low-pressure compressor shaft 15. Advantageously, but without limitation, the notches 84 are formed at the level of the annular shoulder 52.

Each radial tooth 82 is also arranged in a slot 81 in the second nut 73.

As may also be seen in FIG. 3, the radial notches 84 open onto an annular surface 86, centered on the axis X, of the low-pressure compressor shaft 15. In this example, the annular surface 86 is advantageously supported by the annular shoulder 52.

The first rotation locking system 77 also comprises a second ring element 85 which is centered on the longitudinal axis X. The second ring element 85 is split in the general manner of a circlip. The second ring element 85 is received in an annular groove 87 in the second nut 76. The annular groove 87 has an aperture oriented towards the longitudinal axis X. Advantageously, the annular groove 87 is located upstream of the first annular face 74b. More precisely still, the annular groove 87 is formed in the lugs 80. Alternatively, the annular groove 87 is formed by a distance between the first annular face 74a of the second nut and an internal face of the lug 74a. In this way, the second ring element 85 extends upstream of the first ring element 78 and the lugs 80 allow the second ring element 85 to be locked axially. Advantageously, the second ring element 85 is in contact with an upstream face of the first ring element 78.

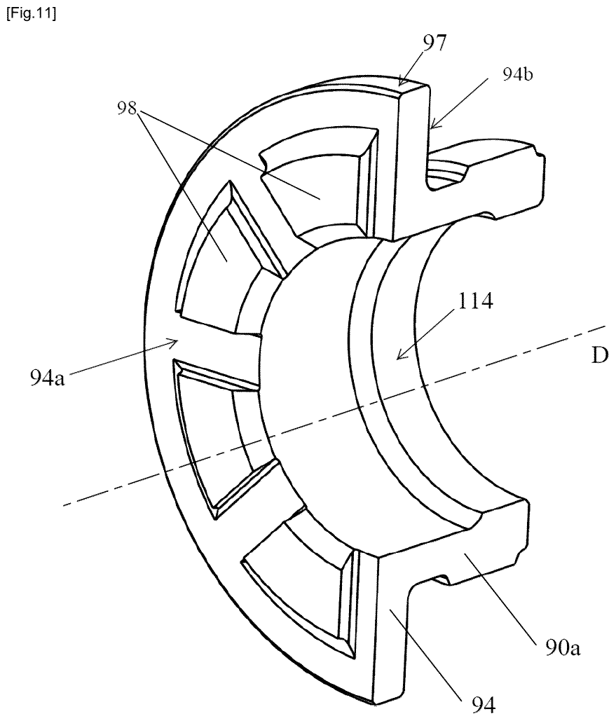

In FIG. 10, the locking device 42 comprises a third nut 90 which is configured to be screwed onto the anti-displacement member 65. The third nut 90 is also configured to be axially immobilized on the input shaft 12. As illustrated, the third nut 90 is advantageously installed in an annular cavity 91 in the input shaft 12. Advantageously, but without limitation, the annular cavity 91 is delimited along the longitudinal axis by an upstream shoulder 92 and by a radial lug 93. The annular cavity 91 is also radially delimited by a wall segment of the downstream end 12b of the input shaft 12.

In the present example, the third nut 90 comprises a cylindrical body 90a of axis D and an annular soleplate 94 extending radially from one end of the third nut 90. The third nut 90 comprises an external thread 95 which is configured to engage with an internal thread 96 of the anti-displacement member 65.

Advantageously, the external diameter of the cylindrical body 90a of the third nut 90 is substantially smaller than the internal diameter of the cylindrical body of the anti-displacement member 65.

The annular soleplate 94 comprises an external peripheral rim 97 (see FIG. 10) which defines a diameter that is smaller than the internal diameter of the downstream end 12b of the input shaft 12. The annular soleplate 94 comprises an upstream face 94a and a downstream face 94b which are opposite each other along the axis D.

Advantageously, the upstream face 94a comprises a plurality of protuberances 98 which extend along the axis D. These protuberances 98 are configured to engage in recesses of a tightening tool (not shown). The latter allows this third nut 90 to be tightened onto the anti-displacement member 65.

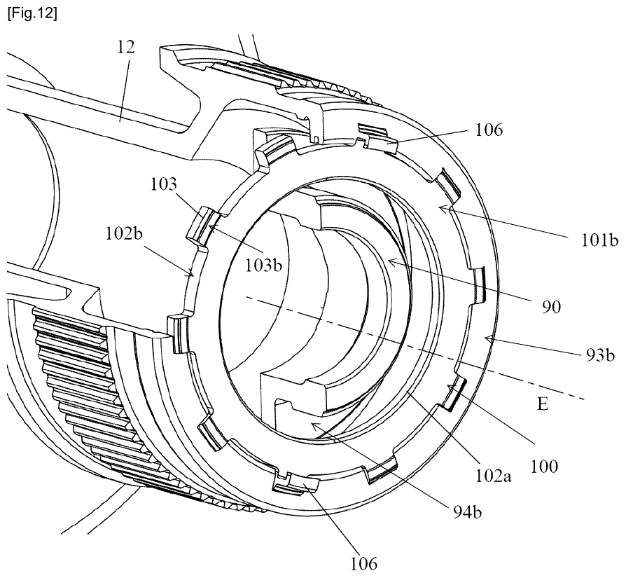

FIGS. 11, 12 and 13 show a second locking system 100 configured to enclose the third nut 90 in the annular cavity 91 of the input shaft 12. Advantageously, the third nut 90 is configured to be axially locked at least in part by the second locking system 100. This axial locking occurs in particular when all the parts are tightened (screwed, etc.). The second locking system 100 advantageously comprises a third ring element 101 of axis E and is centered on the longitudinal axis when installed. The third ring element 101 is used to integrate and enclose the third nut 90 inside the input shaft 12. Advantageously, the third ring element 101 comprises an upstream face 101a and a downstream face 101b which are connected by an internal peripheral rim 102a and an external peripheral rim 102b. The third ring element 101 advantageously comprises a plurality of radial teeth 103 extending radially outwards from the external peripheral rim 102b.

The downstream face 94b of the third nut 90 comes in contact with the upstream face 101a of the third ring element 101. Each radial tooth 103 comprises a downstream face 103b configured to be in contact with an annular face (upstream face 93a) of the radial lug 93. The latter also comprises an annular downstream face 93b axially opposite the upstream face 93a.

As described previously and with reference to FIG. 10, the input shaft 12 comprises a radial lug 93 which extends radially towards the longitudinal axis X. Advantageously, the radial lug 93 comprises a plurality of radial notches 104 which pass through the radial lug 93 on either side along the longitudinal axis X. Each radial notch 104 has a U-shaped radial cross-section. The apertures of the radial notches 104 are oriented towards the longitudinal axis X and open out on either side of the radial lug 93 on the upstream face 93a and on the downstream face 93b.

The third ring element 101 is inserted from downstream at the level of the downstream end 12b of the input shaft 12. To do this, the radial teeth 103 of the third ring element 101 each pass through a radial notch 104 so that the third ring element 101 is arranged in the annular cavity 91 of the input shaft 12. The third ring element 101 is pivoted along the longitudinal axis to make the contact between the downstream faces 103b and the upstream face 93a of the radial lug 93. When installed, the internal peripheral rim 102a of the third ring element 101 extends radially inside the peripheral annular face 105 (or free end of the radial lug 93). The downstream face 94b of the soleplate is configured to come into contact with the upstream face 101a of the third ring element 101.

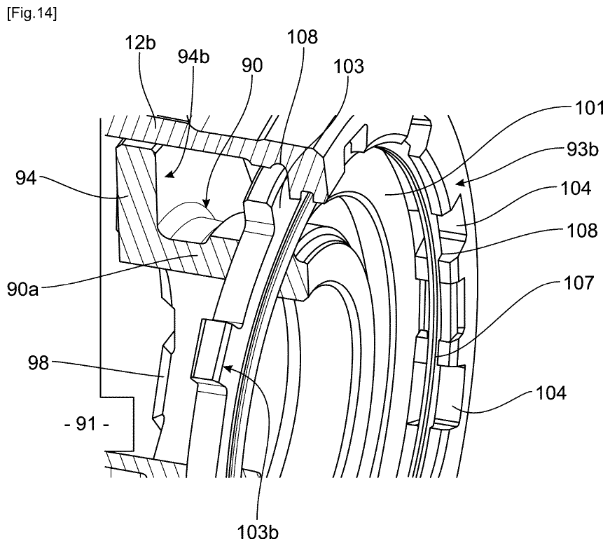

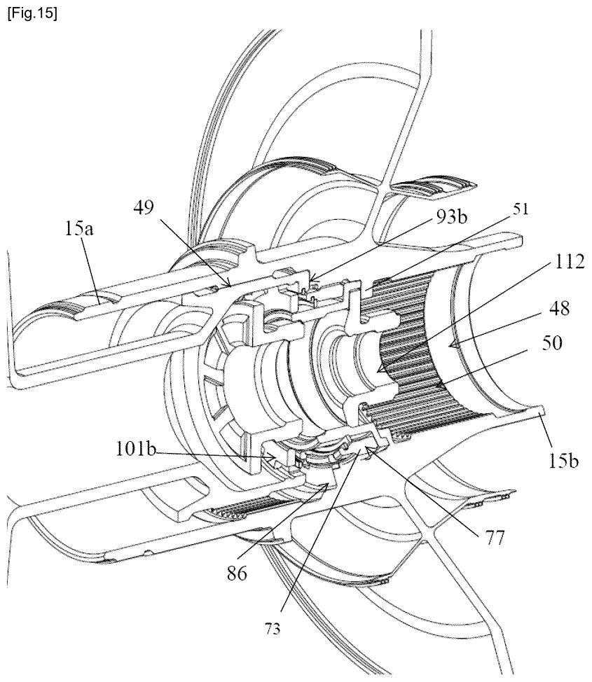

With reference to FIG. 14, the second locking system 100 advantageously comprises a fourth ring element 107 which is centered on the longitudinal axis X. The fourth ring element 107 is configured to axially lock the third ring element 101 in the first module, and here in particular in the input shaft 12. The fourth ring element 107 is split generally like a circlip. The fourth ring element 107 is advantageously received in an annular groove 108 in the input shaft 12 which is centered on the longitudinal axis. The annular groove 108 is located upstream of the upstream face 93a of the radial lug 93. More specifically, the annular groove 108 is formed in the radial lug 93. It has a U-shaped axial cross-section and its aperture opens onto the peripheral annular face 105 of the radial lug 93. As a result of the radial notches formed in the radial lug 93, the latter is in the form of several radial tab sectors which comprise segments of the annular groove. In this way, the fourth ring element 107 extends downstream of the third ring element 101 and into the radial notches 104. The fourth ring element 107 is advantageously arranged opposite the downstream faces of the teeth.

Advantageously, the third ring element 101 comprises means for axially immobilizing the fourth ring element 107. Advantageously, the third ring element 101 comprises two prominences 106 which each extend, along the longitudinal axis X, from a downstream face 103b of a radial tooth 103 of the third ring element 101. The radial teeth 103 supporting the prominences 106 face each other. In other words, these radial teeth 103 are diametrically opposed. In this example, each prominence 106 has an L-shaped axial cross-section.

Each prominence 106 advantageously comprises a first segment extending axially from the downstream face and a second segment extending from one end of the first segment towards the longitudinal axis X. In this way, the second segment is at a distance from the downstream face 103b of the radial tooth 103. In the installation situation, when the downstream faces 103b of certain radial teeth 103 are in contact with the downstream face 93a, the prominences 106 are engaged in corresponding radial notches 104 and the fourth ring element 107 is received in the space formed between the downstream face of the radial tooth 103 and the upstream face of the second segment of the prominence 106. Advantageously, but without limitation, the prominences 106 are engaged in the respective notches after a rotation of the third ring element 101.

Advantageously, the locking device 42 comprises a locking element 110 configured to immobilize the first nut 60 and the third nut 90 in position. Advantageously, but not restrictively, the locking element 110 is engaged with the first nut 60 and the second nut 73. More specifically, the locking element 110 comprises a cylindrical shape with an axis of revolution centered on the longitudinal axis.

The locking element 110 comprises first external splines 111 which engage with internal splines 112 of the first nut 60. The first external splines 111 each extend along the axis of revolution of the locking element 110 and are evenly distributed around the axis of revolution.

In a further advantageous characteristic, the locking element 110 also comprises second external splines 113 which engage with internal splines 114 of the third nut 90. The locking element 110 extends inside the low-pressure compressor shaft 15. The second external splines 113 each extend along the axis of revolution of the locking element 110 and are evenly distributed around the axis of revolution.

Advantageously, but not exclusively, the first external splines 111 and the second external splines 113 are axially offset.

Alternatively, the locking element 110 is screwed onto a thread of the first nut 60 and of the third nut 90. In this case, the locking element 110 comprises external threads cooperating respectively with internal threads of the first and second nuts.

In this example, the locking element 110 comprises a first segment 115a and a second segment 115b which have different cross-sections. In particular, the internal diameter of the second segment 115b is smaller than the internal diameter of the first segment 115a. The first and second segments 115a, 115b are separated by a shoulder 115c.

FIGS. 4 to 16 illustrate the mounting steps of the modules of the turbine engine. We understand that the mounting or reassembly of the modules of the turbine engine may be used by repeating these operations in reverse order.

As shown in FIG. 4, a first step in the method is to install the first nut 60 in the low-pressure compressor shaft 15. The first nut 60 is inserted from the upstream end 15a of the low-pressure compressor shaft 15. The first nut 60 is moved in translation along the longitudinal axis until at least a portion of the downstream annular face 62b of the collar 62 is in contact with the upstream annular surface 51a of the annular projection 51. The first nut 60 is thus trapped on the low-pressure compressor shaft 15.

The method comprises a second step of tightening the low-pressure shaft 9 onto the first nut 60 (the latter being trapped in the low-pressure compressor shaft 15). To this end, the low-pressure shaft 9 is inserted into the low-pressure compressor shaft 15 by sliding using the splines 50, 53. The first nut 60 allows to secure the low-pressure shaft 9 to the low-pressure compressor shaft 15.

In FIGS. 5 and 6, the method comprises a third step of limiting the translational movement of the first nut 60. Translation is limited by the anti-displacement member 65. This step comprises the engagement of the anti-displacement member 65 in the low-pressure compressor shaft 15. The anti-displacement member 65 is displaced in translation along the longitudinal axis so as to take it from a disengaged position to a position of engagement with at least the low-pressure compressor shaft 15. In this engaged position of the anti-displacement member 65, the teeth 68 are engaged in the notches 70 of the low-pressure compressor shaft 15 and the downstream face 67b of the annular wing 67 of the anti-displacement member 65 faces the upstream annular face 62a of the collar 67 of the first nut 60. In this way, the first nut 60 may not move upstream along the longitudinal axis X (or at least over a short distance corresponding to the axial clearance J1) but may still pivot. In particular, the teeth 68 allow to create, at least in part, the axial clearance J1 that allows the first nut 60 to rotate freely.

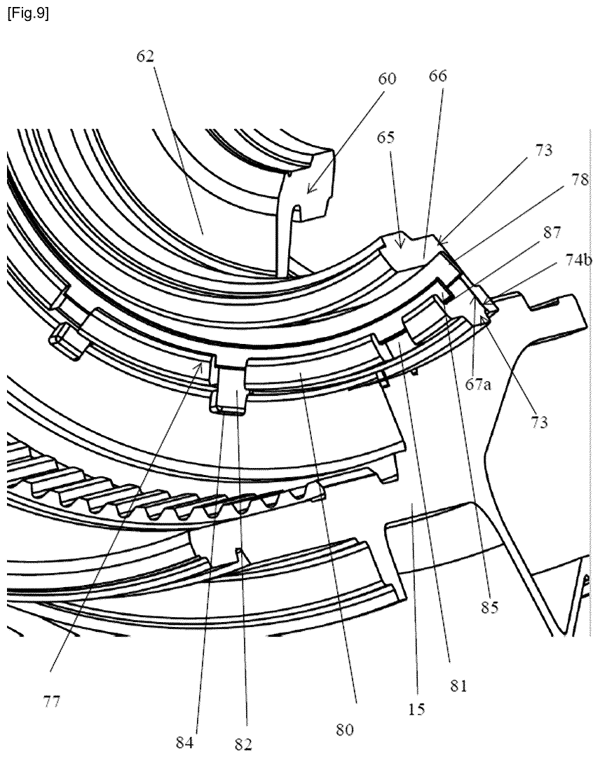

With reference to FIGS. 7 and 8, the method comprises a fourth step which consists of axially immobilizing the anti-displacement member 65. This allows the anti-displacement member 65 to be held so that it axially limits the first nut 60 upstream. To do this, this fourth step comprises a sub-step of screwing the second nut 73 onto the low-pressure compressor shaft 15. In this way, the second nut 73 is moved from an unscrewing position to a screwing position. This screwing step is carried out using another suitable tool (not shown) which is also inserted inside the low-pressure compressor shaft. The second nut 73 is screwed until it is tightened axially against the anti-displacement member 65. In the screwed position, the internal and external threads 74, 76 are engaged and the second annular face 74b of the second nut 73 is in contact with the upstream face 67a of the annular wing 67 of the anti-displacement member 65. The low-pressure compressor shaft 15 is also prevented from moving downstream, as is the low-pressure compressor (i.e. the second nut 73) prevents the low-pressure compressor and the low-pressure turbine from moving closer together). The method also comprises a fifth step which consists of locking the second nut 73 against rotation. The method comprises a sub-step wherein the first locking system 77 is fitted. Advantageously, the first locking system 77 is a nut brake. Of course, other means with the same function are also possible. Initially, the first ring element 78 is moved from a disengaged position to an engaged position. When passing from one position to the other, the radial teeth 82 pass axially through the slots 81 in the second nut 73 and also through the radial notches 84 arranged radially outside the second nut 73. The second nut 73 is screwed on so that the slots face the radial notches 84. In this way, the first ring element 78 extends through both the first nut 60 and the low-pressure compressor shaft 15 so that the radial teeth 84 may not rotate about the longitudinal axis X. This is also possible because the external diameter of the radial teeth is greater than the external diameter of the second nut 73.

The first ring element 78 extends radially around the anti-displacement member 65. In a second step, the second ring element 85 is moved from a disengaged position to an engaged position. In the engaged position, the second ring element 85 is inserted into the annular groove 87 of the second nut 73. The radial teeth are axially blocked by the second ring element 85.

With reference to FIG. 10, the method comprises a sixth step consisting of installing the third nut 90 on the input shaft 12. The third nut 90 is inserted from the downstream end 12b of the input shaft 12 in an upstream direction. The third nut 90 is then in the cavity 91 of the input shaft 12. The installation is possible because the external diameter of the annular soleplate 94 is smaller than the internal diameter of the input shaft 12 measured at the level of the peripheral annular face 105 of the radial lug 93.

The third nut 90 is put on standby after being inserted into the cavity 91.

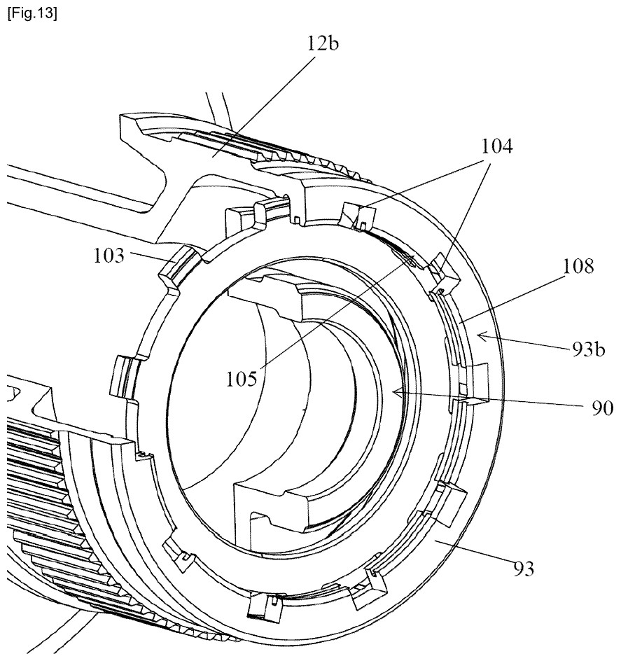

Referring to FIGS. 11 and 12, the method comprises a seventh step of trapping the third nut 90 in the cavity 91. To do this, the seventh step comprises a sub-step wherein the third ring element 101 is mounted on the input shaft 12. The third ring element 101 is moved from a disengaged position to an engaged position. When passing from one position to the other, the third ring element 101 is positioned so that the radial teeth 103 pass axially through the radial notches 104. Once the third ring element 101 is in the cavity 91, it is rotated as shown in FIG. 12 so that the radial teeth 103 no longer face the radial notches 104. In the engaged position, the downstream faces 103b of the teeth face the upstream face 93a of the radial lug 93. The downstream face 94b of the third nut 90 also faces the upstream face 101a of the third ring element 101, against which it is configured to be in contact with. The internal diameter of the ring element 101 is smaller than the external diameter of the annular soleplate 94 and the third ring element 101 is configured to extend around the cylindrical body of the third nut 90. This configuration allows to reduce the radial aperture at the downstream end 15b of the input shaft 12 delimited by the peripheral annular face 105, which prevents the third nut 90 from being extracted downstream. As the internal diameter of the third ring element 101 is smaller than the internal diameter of the lug 93 (delimited by the annular surface 105), the contact surface with the third ring element 101 is larger. The third nut 90 is enclosed or trapped in the cavity 91.

Referring to FIG. 14, the method comprises an eighth step consisting of trapping the third ring element 101 in the cavity 91. To do this, the method comprises a sub-step wherein the fourth ring element 107 is moved from a disengaged position to an engaged position. In the engaged position, the fourth ring element 107 is inserted into the annular groove 108 of the input shaft 12. The radial teeth 103b are axially locked by the fourth ring element 107. More specifically, the third ring element 101 may not move axially downstream.

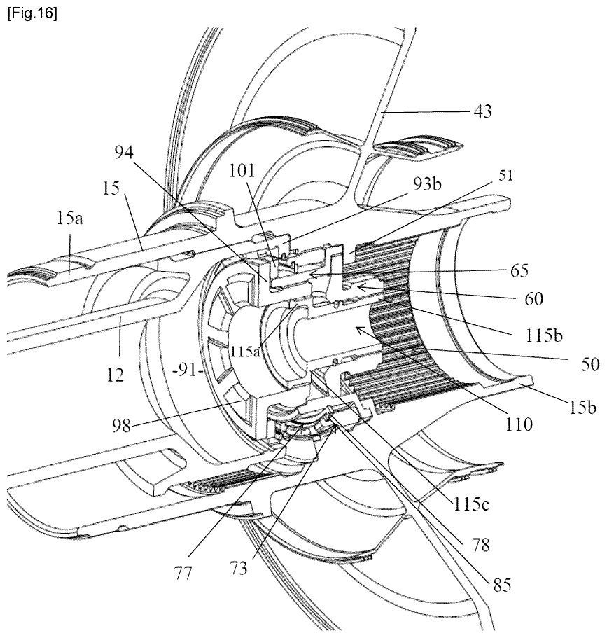

With reference to FIG. 15, the method comprises a ninth step consisting of securing the input shaft 12 to the low-pressure compressor shaft 15. To do this, the downstream end 12b of the input shaft 12 is inserted inside the upstream end 15a of the low-pressure compressor shaft 15. The input shaft 12 is free to slide along the longitudinal axis relative to the low-pressure compressor shaft 15 by means of the splines 47, 49. In this way, the input shaft 12 is also moved from a disengaged position to a disengaged position. In the engaged position, the splines 47, 49 are engaged and the downstream face 93b of the downstream end 12b of the input shaft 12 is in contact with the annular surface 86 of the low-pressure compressor shaft 15.

Referring to FIG. 16, the method comprises a tenth step consisting in screwing on the third nut 90. In this way, the third nut 90 is moved from an unscrewing position to a screwing position. This screwing step is carried out using a suitable tool (not shown) which is also inserted into the input shaft 12 of the speed reducer 3 from upstream. The third nut 90 is screwed until it is tightened axially against the third ring element 101. In the screwed-on position, the external thread 95 of the third nut 90 is engaged with the internal thread 72 of the anti-displacement member 65. Similarly, in the screwed position, the downstream face 94b of the third nut 90 is in contact with the upstream face 101a of the third ring element 101.

Finally, the method comprises an eleventh step consisting in engaging the locking element 110. The locking element 110 is moved from a disengaged position to an engaged position. The locking element 110 is previously inserted into the low-pressure compressor shaft from upstream and from the input shaft 12. The engagement step is carried out using a suitable tool (not shown) which is also inserted inside the input shaft 12 from upstream. In the engaged position, the first external splines of the locking element 110 are engaged with the internal splines 112 of the first nut 60 and the second external splines 113 of the locking element 110 are engaged with the internal splines 114 of the third nut 90. The locking element 110 prevents the first and second nuts from being loosened or unscrewed.

With such a configuration, only the input shaft 12 of the speed reducer 3 may be dismounted and mounted, keeping the other shafts of the modules in the mounted position. The various nuts 60, 73, 90 and the members (ring elements, anti-displacement members and locking elements) are tightened together to prevent rotation on the one hand and axial displacement on the other.

The low-pressure compressor shaft 15 is independent of the input shaft 12 and of the low-pressure shaft 9. When the input shaft 12 is dismounted, the low-pressure shaft 9 remains secured to the low-pressure compressor shaft 15 via the first nut 60, the anti-displacement member 65 and the second nut 73.

1. A turbine engine in particular for an aircraft, the turbine engine having a longitudinal axis and comprising:
a first module comprising a speed reducer which comprises an input shaft centered on the longitudinal axis,
a second module comprising a low-pressure compressor the second module being connected to the first module,
a third module comprising a low-pressure shaft which is centered on the longitudinal axis X, the low-pressure shaft comprising an upstream end connected to the input shaft, and
a locking device configured so as to axially immobilize the third module with respect to the first module,
wherein the locking device is configured so as to axially immobilize the second module with respect to the first module and the third module and comprises:
a first nut which is screwed onto a thread of the upstream end of the low-pressure shaft and in contact with an annular projection of the second module,
an anti-displacement member configured to axially limit the displacement of the first nut,
a second nut which is screwed onto a thread of the second module and which is configured so as to axially immobilize the anti-displacement member, and
a third nut which is screwed onto the anti-displacement member.

2. The turbine engine according to claim 1, wherein the locking device comprises a locking element cooperating with the first nut and the third nut.

3. The turbine engine according to claim 1, wherein the first nut is mounted so as to rotate freely about the longitudinal axis.

4. The turbine engine according to claim 1, wherein the second module comprises a low-pressure compressor shaft which is connected to the low-pressure compressor and which is centered on the longitudinal axis, the low-pressure compressor shaft being connected to the input shaft and to the low-pressure shaft.

5. The turbine engine according to claim 4, wherein the low-pressure compressor shaft comprises the annular projection and the first nut comprises a downstream face in contact with an upstream face of the annular projection.

6. The turbine engine according to claim 4, wherein the anti-displacement member comprises a plurality of teeth each configured to engage in a notch in the low-pressure compressor shaft.

7. The turbine engine according to claim 6, wherein the plurality of teeth has an external diameter greater than an external diameter of a collar of the first nut.

8. The turbine engine according to claim 1, wherein the second nut is configured to be locked against rotation by a first locking system.

9. The turbine engine according to claim 4, wherein the first locking system comprises:
a first ring element, centered on the longitudinal axis and configured to come in contact with a radial annular face of the second nut, the first ring element comprising a plurality of radial teeth each configured to engage in a radial notch of the low-pressure compressor shaft, and
a second ring element, centered on the longitudinal axis and received in an annular groove of the second nut, the annular groove being arranged upstream of the radial annular face.

10. The turbine engine according to claim 1, wherein said turbine engine comprises a second locking system configured so as to enclose the third nut in an annular cavity of the input shaft.

11. The turbine engine according to claim 10, wherein the second locking system comprises:
a third ring element, centered on the longitudinal axis, and comprising a plurality of radial teeth which have downstream faces configured to be in contact with an annular face of the input shaft, the third ring element comprising an upstream face with which a downstream face of the third nut abuts against, and
a fourth ring element, centered on the longitudinal axis, received in an annular groove of the input shaft, the fourth ring element facing the downstream faces of the radial teeth.

12. The turbine engine according to claim 1, wherein the first module comprises a fan which is connected to a fan shaft and which is arranged upstream of the second module, the low-pressure shaft driving the fan shaft in rotation by means of the speed reducer.

13. The turbine engine according to claim 12, wherein the fan is ducted.

14. A method for mounting a turbine engine according to claim 1, wherein said method comprises the steps of:
screwing the first nut onto the low-pressure shaft,
limiting in translation the first nut on the low-pressure compressor shaft along the longitudinal axis by means of the anti-displacement member,
immobilizing axially the anti-displacement member by means of the second nut,
screwing the third nut onto the anti-displacement member.

15. The method according to claim 14, wherein said method comprises a step of engaging a locking element on the third nut and on the first nut.
